(19) United States
(12) Patent Application Publication
(10) Pub. No.: US 2026/0359604 A1
(43) Pub. Date: Nov. 12, 2026

(54) A BLACK HOLE PREDICTION AND DETECTION SYSTEM BY COMPUTER-AIDED MACHINE LEARNING IN SOFTWARE BACKBONE INFRASTRUCTURE NETWORKS AND AN OPERATION METHOD THEREOF

(71) Applicant: BTS KURUMSAL BILISIM TEKNOLOJILERI ANONIM SIRKETI, Atasehir/Istanbul (TR)

(72) Inventors: Kiymet KAYA ÜNAL, Sariyer/Istanbul (TR); Sule ÖGÜDÜCÜ, Sariyer/Istanbul (TR); Gökhan YURDAKUL, Üsküdar/Istanbul (TR); Aytaç KARAMESEOGLU, Kadikoy/Istanbul (TR)

(21) Appl. No.: 19/116,343

(22) PCT Filed: Dec. 29, 2023
(86) PCT No.: PCT/TR2023/051866

§ 371 Date: Mar. 27, 2025

(30) Foreign Application Priority Data
Dec. 20, 2023 (TR) 2023/017827

(51) Int. Cl. G06N 3/0455; G06N 3/088

(52) U.S. Cl. CPC G06N 3/0455; G06N 3/088

(57) ABSTRACT

The invention relates to a black hole prediction and detection system by computer-aided machine learning in software backbone infrastructure networks and an operation method thereof. The black hole prediction and detection system by computer-aided machine learning of the invention predicts and detects outlier network behavior anomalies, thereby generating a warning, detects the black hole anomalies which have not yet been seen without any need to retrain the model, allows the black hole anomalies to be directly and instantly predicted without any need for tagging the data, avoids the problem of learning from imbalanced data in the classification problems caused by data tagging being overcome, without requiring extra time and workload, provides general black hole prediction which may adapt to varying topologies, detects the point, contextual and collective anomalies together for black hole prediction, and analyzes and interprets the instances detected as black holes by computer-aided machine learning, thereby explaining the grounds for detection.

### TECHNICAL FIELD OF THE INVENTION

The invention relates to a black hole prediction and detection system by computer-aided machine learning in software backbone infrastructure networks and an operation method thereof.

### STATE OF THE ART

Today, the tools providing Internet service to users are called Internet service providers (ISPs), and there are already different Internet service providers and different infrastructure services. It is of great importance that the services offered to users by the Internet service providers (ISPs) are adequate and uninterrupted. The provision of these services depends on whether the routers used in the backbone infrastructure networks operate properly. Certain situations negatively affecting the end-to-end connection may occur, in which the routers drop data packets without sending any fault notification and notifying the sender, during data packet sending, and those situations are called black holes or silent failures. In the context of computer networks, a black hole is defined as a place where incoming packages are destroyed or discarded without informing the sender or receiver of their failed delivery. When data packets are routed to an off-line or disconnected router, they are sent to a black hole. When this happens, all packets forwarded to the router are discarded and lost. Black hole detection performed by examining the network topology is very challenging considering the possibility of failure of more than one router at the same time. Diagnostic tests to localize the problem after receiving a disconnection notification are often costly and time-consuming.

In the state of the art, computer network anomaly detection processes generally focus on detecting one of the three main types of anomalies: point, contextual, or collective anomalies. FIG. 1 shows an example of each of these anomaly types (a point anomaly, a contextual anomaly, and collective anomalies) on time series data. A point anomaly indicates a random irregularity, an extremum, or a sudden deviation having no meaning, which exists far outside of a certain norm, often referred to as an outlier. A contextual anomaly refers to a data point, the value of which may be within the expected value range of the time series, but deviates from the values of the surrounding observations. Therefore, an example of a normal class in a particular context may be categorized as abnormal in a different context. A collective anomaly, on the other hand, is a group of interconnected data points which fall outside of a normal behavior, especially in sequential, spatial, and graph data. In a collective anomaly, the individuals of the group are not anomalies by themselves, but an anomaly occurs when they are a set of interconnected, related, or sequential instances.

In the state of the art, different failures or attacks may be observed simultaneously with the black hole in the backbone infrastructure networks. There is a need for a system which may detect black holes and the other outliers in the network at the same time, and may give a warning in case of outlier network behaviors as in FIG. 1.a, even if there is no black hole anomaly.

In the state of the art, anomalies in computer networks may change over time, and new anomalies may occur. In this context, it is obvious that there is a need for a prediction and detection system which may detect newly added black hole anomalies, in other words, the unseen black holes, without any need to retrain the model.

Anomaly prediction studies in the state of the art mostly perform supervised/semi-supervised learning with labeled data. A process of tagging meaningful parts of data according to the categories needed is called “data tagging”. Data tagging is also defined as the introduction of meanings in data to machine learning. The labeled data are collected, thereby generating a training set, and the model is trained with this set. Data tagging is a labor-intensive and time-consuming process, and is challenging in sudden decision-making situations. For these reasons, there is a need for a system which may directly and instantly predict black hole anomalies using the unlabeled data. Even if data tagging is overcome by using heuristics or simple rules, the problem of learning from the imbalanced data arises in classification problems as a new problem. In this problem which is frequently seen in anomaly detection studies in computer networks, the prediction model tends to learn the many instances class, but not the few instances class. As a solution to this, there are sampling approaches (upsampling, downsampling and hybrid sampling) and algorithmic approaches in the literature. However, these approaches may not always show the desired performance, and artificializes the real-world data by distorting its statistical properties, or by increasing the data belonging to the few instances class with the data instances that have not been seen in the real world, and requires extra experimentation, time and workload.

In the state of the art, the Internet service providers (ISPs) provide Internet service to many customers in various network topologies, and it takes an extra effort to develop a black hole prediction model specific to each topology. Therefore, the need for a general black hole prediction model which may adapt to the varying topologies is increasing day by day.

In the state of the art, there is no system which predicts black holes specific to the backbone networks. Current studies on the state of the art have been carried out on Mobile Ad-hoc Networks (MANETs), Wireless Ad-hoc Networks (WANETs) and Wireless Sensor Networks (WSNs). In the literature, there is no system for black hole prediction which may detect point, contextual and collective anomalies together.

In the state of the art, there is no study in which the instances detected as black holes by the machine learning-based prediction systems and methods are analyzed and interpreted via the explainable machine learning systems and methods, and the grounds for the detection are explained.

There is a need for a black hole prediction and detection system and an operation method thereof in which all problems are eliminated, due to the facts that the black hole anomaly prediction and detection systems in the state of the technique are limited and insufficient, a system which gives a warning in case of outlier network behaviors is not included in the state of the art, there is a need for a prediction system which may detect unseen black hole anomalies, the problem of learning from the imbalanced data occurs in the anomaly detection systems in the state of the art art, there is no general black hole prediction system which may adapt to the varying topologies is not yet included in the state of the art, there is no system in the literature, which may detect point, contextual and collective anomalies together for the black hole prediction, and there is no system and method in the state of the art, in which the machine learning system and methods are analyzed and interpreted, and therefore the grounds for the detection are explained.

### SUMMARY AND OBJECTIVES OF THE INVENTION

The invention discloses a black hole prediction and detection system by computer-aided machine learning in software backbone infrastructure networks and an operation method thereof. The black hole prediction and detection system by computer-aided machine learning of the invention predicts and detects outlier network behavior anomalies, thereby generating a warning, detects the black hole anomalies which have not yet been seen without any need to retrain the model, allows the black hole anomalies to be directly and instantly predicted without any need for tagging the data, avoids the problem of learning from imbalanced data in the classification problems caused by data tagging being overcome, without requiring extra time and workload, provides general black hole prediction which may adapt to varying topologies, detects the point, contextual and collective anomalies together for black hole prediction, and analyzes and interprets the instances detected as black holes by computer-aided machine learning, thereby explaining the grounds for detection.

An object of the invention is to provide a black hole prediction and detection system by computer-aided machine learning in software backbone infrastructure networks and an operation method thereof, wherein the system may detect black holes and other outliers in the network at the same time and give a warning in case of outlier network behaviors as in FIG. 1.a, even if there is no black hole anomaly. The invention provides a black hole prediction and detection system by computer-aided machine learning in software backbone infrastructure networks which give a warning in case of outlier network behaviors, and an operation method thereof, by DBSCAN. In the black hole prediction and detection system of the invention, the point computer network failures occur simultaneously with the black hole. The Black Hole Prediction Model used in the system of the invention includes the DBSCAN (Density-Based Spatial Clustering of Applications with Noise) method, and thus the outliers in the network are detected. The system of the invention provides a system which may detect black holes and the other outliers in the network at the same time, and may give a warning in case of outlier network behaviors even if there is no black hole anomaly.

Another object of the invention is to provide a prediction and detection system which may detect newly added black hole anomalies, in other words, the unseen black holes, without any need to retrain the model, and an operation method of the system. In the invention, a prediction and detection system which may detect newly added black hole anomalies, in other words, the unseen black holes, without any need to retrain the model, and an operation method of the system are provided by unsupervised learning. In the system of the invention, the unsupervised learning is applied via the black hole prediction model, and an adaptation to the varying network anomaly behaviors may be achieved. Thanks to the unsupervised learning approach, newly added, unseen black hole anomalies may be detected without retraining the model.

The invention provides a system which may directly and instantly predict the black hole anomalies via the unlabeled data without the problem of learning from imbalanced data, and an operation method of this system. A system which may directly and instantly predict the black hole anomalies via the unlabeled data without the problem of learning from the imbalanced data, and the operation method of this system are provided by the unsupervised learning which is not affected by the class distributions in the invention in the same way as the supervised methods. In addition, the real-world data is not artificialized and an extra experiment, time and workload are eliminated, while the invention provides a system which may directly and instantly predict the black hole anomalies via the unlabeled data without the problem of learning from the imbalanced data, and the operation method of this system. The black hole prediction model used in the system of the invention runs directly on the unlabeled computer network data, and thus a system which may predict the black holes instantly and directly is presented. The supervised/semi-supervised learning anomaly prediction approaches in the literature require the labeled data and extra time, workload, etc. On the other hand, the black hole prediction model is enabled to run directly on the unlabeled data collected from the backbone network, and thus, no problem of learning from the imbalanced data occurs, which is frequently seen in anomaly classification problems in the labeled data.

The invention provides a general black hole prediction and detection system which may adapt to the varying topologies and an operation method thereof. In the invention, a general black hole prediction and detection system which may adapt to the varying topologies and an operation method thereof are provided by an artificial intelligence-based prediction model. The black hole prediction model used in the system of the invention is based on machine learning-based algorithms and is compatible with the varying topologies.

The invention provides a black hole prediction and detection system which may detect point, contextual and collective anomalies together, and an operation method thereof. A black hole prediction and detection system which may detect contextual and collective anomalies together, and the operation method thereof are provided by the Convolutional AutoEncoder (Conv-AE) architecture, which is implemented in the invention via the sliding window method.

Another object of the invention is to provide a black hole prediction and detection system and an operation method thereof, in which the instances detected to be black holes are analyzed and interpreted by the explainable machine learning systems and methods, and the grounds for the detection are explained. A black hole prediction and detection system in which the instances detected to be black holes are analyzed and interpreted and the grounds for the detection are explained, and the operation method thereof are provided by the explainable machine learning systems and methods in the invention. The explainable intelligence methods are used in the system of the invention and thus, an explanation is provided for the black hole prediction.

### DESCRIPTION OF THE FIGURES

FIG. 1 is three types of anomaly classification: (a): Point Anomaly (b): Contextual Anomaly (c): Collective Anomalies.

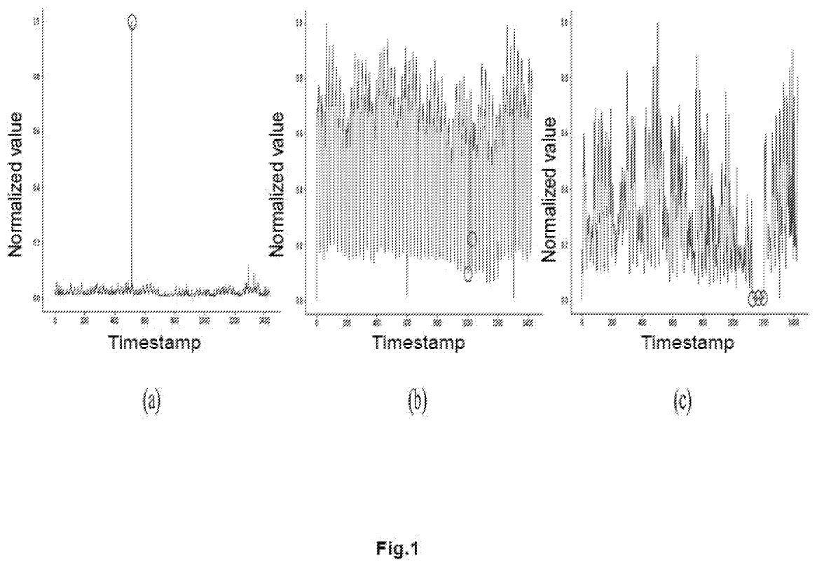

FIG. 2 is a schematic representation of the black hole prediction system model used in the system of the invention.

FIG. 3 is a flow chart of data collection.

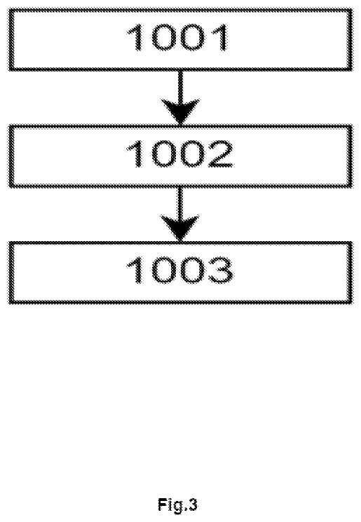

FIG. 4 is a flowchart showing the implementation of the data preprocessing steps.

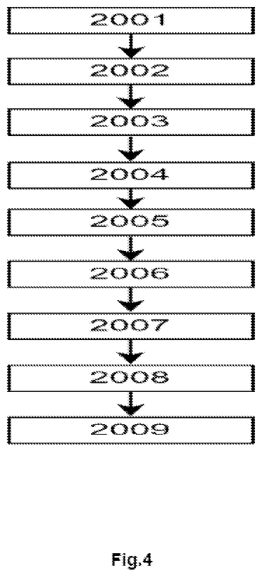

FIG. 5 shows the detection of outliers by DBSCAN and acquisition of the data that converges to normal.

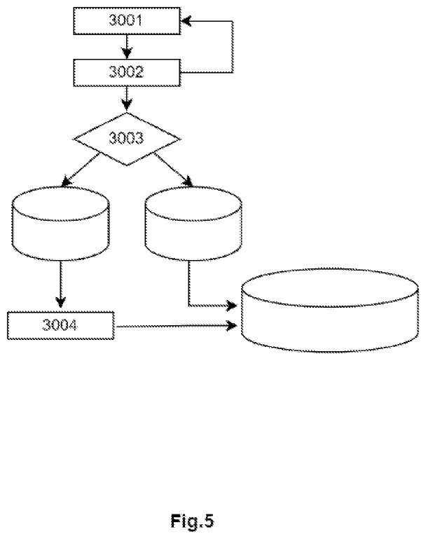

FIG. 6 is a black hole prediction model and explanation of the black hole instances with XAI.

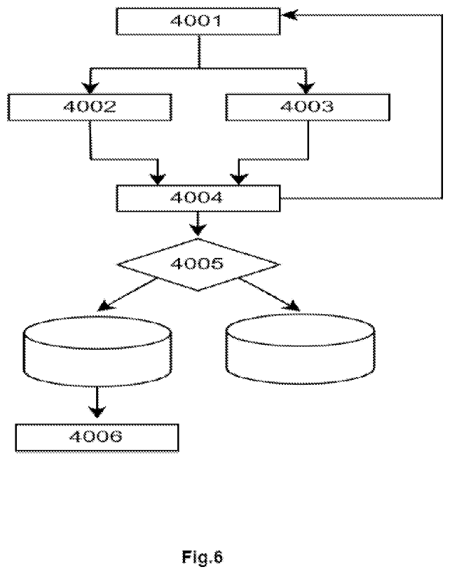

FIG. 7 is a representative view of the black hole prediction model used in the system of the invention.

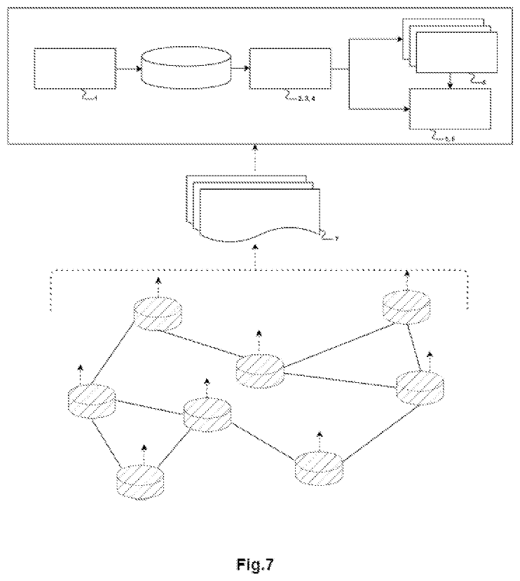

FIG. 8 is the architecture of the problem-specific convolutional autoencoder, wherein x: Input, y: Convolutional-1D, z: T-Convolutional-1D, q: Output, t: Attributes, u: Window size, and w: Instances.

FIG. 9 is (a) Normalized value of the attribute of the mean output packet ratio in time series data (b) Point anomaly instances detected by DBSCAN (c) Data obtained by updating the values of point anomaly instances with the closest normal group instance values (d) Black hole instances detected by the Black Hole Prediction Model.

### DESCRIPTION OF THE REFERENCES IN THE FIGURES

1. Data collection module
2. Data preprocessing module
3. Unlabeled data tagging module
4. Anomaly data replacing module
5. Machine learning-based black hole prediction module
6. Machine learning-based method explanation module
7. Module for collecting current data from YANG model sensors
8. Off-line updating module of the black hole prediction model
1001. Examining YANG data models
1002. Determining the YANG data models and attributes
1003. Collecting the time series data
2001. Removing the single value-containing attributes from the data
2002. If numeric attributes contain alphabetic characters, detecting these instances and removing them from the data
2003. Detecting the non-numeric categorical attributes and making them ready for use of the machine learning algorithms
2004. Detecting the values which are not present in the dataset and filling in these values using the methods of backfilling the missing values in the dataset (bfill) and/or forward filling the missing values in the dataset (ffill)
2005. Generating a correlation matrix to understand the relationship between the attributes and keeping only one of the highly correlated attributes in the dataset and removing the other to reduce the calculation time and increase the generalization ability of the models
2006. Determining the acceptable limits for the attribute-based sparsity rate, which is the number of zeros in an attribute column divided by the number of instances of the attribute, and keeping the attributes within these limits in the data and eliminating the others
2007. Time-dependent visualizing the attributes to observe time series characteristics of the black hole data
2008. Generating the required time-related attributes such as minutes, week of the year, day of the week, etc., by being acquired from the instance recording date information
2009. Generating the additional attributes which are thought to more accurately express the black hole characteristic and the input/output packet/data/load ratios to be made on the existing attributes.
3001. Investigating the correct values for two main hyperparameters, Epsilon and minimum points,
3002. Deciding on the most accurate DBSCAN model based on the performance metrics
3003. Marking the data as point anomaly or normal by DBSCAN
3004. Updating the values of the point anomaly instances with the closest instance values of the normal group
4001. Investigating the problem-specific autoencoder architecture
4002. Checking the black hole prediction performance of the candidate autoencoder models using the attribute-based visualizations
4003. Evaluating the performance of the candidate encoder models according to the detection precision.
4004. Combining the evaluation results and deciding on the most accurate autoencoder model
4005. Marking the data as a black hole or normal with a black hole prediction model comprising an autoencoder specially designed for the problem
4006. Generating an explanation for the instances detected as black holes by the explainable machine learning methods

### Detailed Description of the Invention

The invention relates to a black hole prediction and detection system by computer-aided machine learning in software backbone infrastructure networks and an operation method thereof. A black hole prediction and detection system by computer-aided machine learning comprising at least one processor comprises:
a data collection module (1) which determines the relevant data set during the black hole detection, constantly monitors the system by a remote connection unit and while doing so, prevents the system from being exhausted by the data flow traffic, thereby not affecting the performance of the system, wherein the data collection module observes and collects the network parameters in a router via the sensors in the routers and is a structure where time series network data is collected using YANG data models,
a data pre-processing module (2) which prepares the data for the machine learning algorithms in the studies carried out on data using machine learning-based algorithms and is a structure where the data pre-processing processes are carried out,
an unlabeled data tagging module (3) which is a structure in which outliers such as point anomalies in the data are obtained by creating a new clustering model suitable for the problem via the Density-Based Spatial Clustering of Applications with Noise (DBSCAN), one of the machine learning clustering methods,
an anomaly data replacing module (4) which obtains data converged to a normal group from the unlabeled data,
a machine learning-based black hole prediction module (5) which helps the data to converge to normal and is used in combination with the problem-specific autoencoder Conv-AE architecture sliding window technique,
an explanation module (6) of the machine learning-based method, in which a score is obtained for the black hole instances at the model output via the explainable machine learning method and determines from which neurons in the network and which attributes in the data this score originates,
a module (7) for collecting current data from YANG model sensors, which is a structure in which the current time series network data collected using YANG data models is periodically transferred to the system,
an off-line updating module (8) of the black hole prediction model, which is a structure in which the machine learning-based black hole prediction module (5) is updated.

Here, said remote connection unit in the data collection module (1), which determines the relevant data set in the black hole detection and constantly monitors the system by a remote connection unit, is Ethernet or Wifi. In addition, said data collection module (1) is a hard disk. In addition, the module (7) for collecting current data from YANG model sensors, which is a structure in which the current time series network data collected using YANG data models is periodically transferred to the system in order to observe and collect the network parameters in the router by the remote connection unit that provides communication, is Ethernet or Wifi. the module (7) for collecting current data from YANG model sensors, which is a structure in which the current time series network data collected using YANG data models is periodically transferred to the system in order to observe and collect the network parameters in the router by the remote connection unit that provides communication, is a hard disk.

The data preprocessing module (2) is a structure in which the data preprocessing studies are carried out, which make the data suitable for machine learning algorithms, which is one of the most important steps in the studies carried out on data with machine learning-based algorithms. One of the most important steps in the studies carried out on data with machine learning-based algorithms is making the data suitable for the machine learning algorithms. even the most successful learning algorithms may not produce the expected performances in case of data that is not organized accurately.

The unlabeled data tagging module (3) is a structure in which outliers such as point anomalies in the data are obtained by creating a new clustering model suitable for the problem via the Density-Based Spatial Clustering of Applications with Noise (DBSCAN), one of the machine learning clustering methods.

The anomaly data replacing module (4) obtains data converged from the unlabeled data to the normal group. When the outliers in the structure of the unlabeled data tagging module are removed from the data, gaps occur in the data and the data loses its time series characteristic. Therefore, the values of these instances are updated with the closest instance values of the normal group by using the methods of backfilling (bfill) the missing values in the dataset and/or forward filling (ffill) the missing values in the dataset. In this way, the data converged to the normal group are obtained from the unlabeled data.

The machine learning-based black hole prediction module (5) helps to converge the data to normal and is used together with the Conv-AE architecture sliding window technique, which is designed specifically for the problem. Anomalies found by DBSCAN during the tagging step of the unlabeled data include outliers in the data and do not include time series anomalies. Detection of these helps to converge the data to normal.

The machine learning-based method explanation module (6) is a structure in which a score is obtained for the black hole instances at the model output via the explainable machine learning method and determines from which neurons in the network or which attributes in the data this score originates.

The operation method of a black hole prediction and detection system by computer-aided machine learning comprising at least one processor in software backbone infrastructure networks of the invention comprises the following process steps:
i. examining the YANG data models (1001),
ii. determining the YANG data models and attributes thought to be associated with the black hole (1002),
iii. collecting the time series data (1003),
iv. removing the attributes which do not contain any information on time-varying network conditions in black hole prediction, but a single value from the data (2001),
v. detecting instances for which the numeric attributes contain alphabetic characters due to typographical errors and errors caused by a human error during a data recording process, and removing them from the data (2002),
vi. detecting the machine learning algorithms of the non-numeric categorical attributes as they have no input and making them ready for use using one-hot-encoding and label encoding algorithms (2003),
vii. detecting the values which are not present in the dataset and filling in said values by the method of back filling (bfill) the missing values in the dataset and/or forward filling (ffill) the missing values in the dataset, instead of removing said values from the data (2004),
viii. understanding the relationship between the attributes by generating a correlation matrix and reducing the calculation time and increasing the generalization ability of the models by keeping only one of the highly correlated attributes in the dataset and removing the other (2005),
ix. determining the acceptable limits for the attribute-based sparsity rate, which is the number of zeros in an attribute column divided by the number of instances of the attribute, and keeping the attributes within these limits in the data and eliminating the others (2006),
x. observing the time series characteristics of the black hole data by time-dependent visualization of the attributes (2007),
xi. due to the fact that the data flow in the network shows a time-dependent pattern, generating the required time-related attributes such as minutes, week of the year, day of the week, etc., by being acquired from the instance recording date information (2008),
xii. generating the additional attributes which are thought to accurately express the black hole characteristic and the input/output packet/data/load ratios to be made on the existing attributes (2009),
xiii. investigating the correct values for two basic hyperparameters, Epsilon and Minimum Points, for the most accurate DBSCAN method (3001),
xiv. deciding on the accurate DBSCAN model based on Silhouette Score and Davies Bouldin Score performance metrics (3002),
xv. tagging the data as point anomaly or normal by DBSCAN (3003),
xvi. updating the values of the point anomaly instances with the closest instance values of the normal group by using the bfill and/or ffill methods (3004),
xvii. investigating the problem-specific autoencoder architecture (4001),
xviii. checking the black hole prediction performance of the candidate autoencoder models using the attribute-based visualizations as the data is unlabeled (4002),
xix. evaluating the performance of the candidate autoencoder models according to the detection precision to be determined by a specialist (4003),
xx. combining the evaluation results and deciding on the accurate autoencoder model (4004),
xxi. marking the data as a black hole or normal with the machine learning-based black hole prediction module (5) containing an autoencoder specially designed for the problem (4005),
xxii. generating an explanation for the instances detected as black holes by XAI methods (4006)

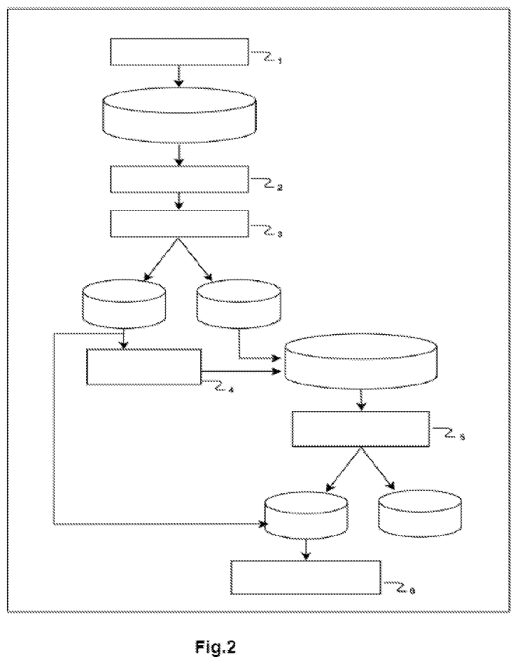

The black hole prediction model used in the black hole prediction and detection system of the invention is shown in FIG. 2. The unlabeled time series computer network data is collected by the data collection module (1), and the data preprocessing process required to make the same suitable for the machine learning/deep learning algorithms is performed by the data preprocessing module (2). In the tagging step of the unlabeled data, the pre-processed data is clustered (3) by the unlabeled data tagging module (3) via DBSCAN, and the data set is divided into two groups. The point anomalies and normal anomalies found with DBSCAN, point anomalies in the data, also called outliers, include deviations from the context-independent data. The detected point anomaly instances are replaced with the closest normal instance data, and the data converged to the normal class is obtained by the anomaly data replacing module (4). As the object of the system of the invention is to detect and, if possible, stop the black hole failure/attack before it occurs, the black hole prediction problem is formulated as the detection of the changes in the time series pattern. Therefore, when the history is ‘m’ minutes, the window size is: ‘m’ and the current time is: ‘t’, the time series data converged normal for (‘t−1’, ‘t−2’, . . . , ‘t−m’) are prepared by a window sliding approach and the unsupervised convolutional autoencoder-based machine learning-based black hole prediction module (5) is presented as an input. The autoencoder is provided so as to predict both the contextual and collective anomalies simultaneously. The convolutional layer in the autoencoder is particularly useful for detecting the collective anomalies by addressing the spatial properties of the data. On the other hand, preparing the data by the window sliding approach enables the detection of the contextual anomalies, especially taking into account the time series characteristic of the data. Finally, the explanation of the grounds for detection using the explainable machine learning methods for the instances detected as black holes by the machine learning-based black hole prediction module (5) is presented by the machine learning-based method explanation module (6).

All modules in the system and method of the invention perform the processes mentioned in the invention through the processor included in the computer via a software.

Autoencoders are a special model of deep neural networks which attempt to encode and reconstruct the input data. An autoencoder consists of three basic parts: an encoder, which encodes the input data into a new-dimensional version, a bottleneck: a bottleneck, which is the transition part in which the encoded data is prepared for a decoding process, and a decoder, which is a reconstruction part. The decoder is trying to produce an output similar to the input data.

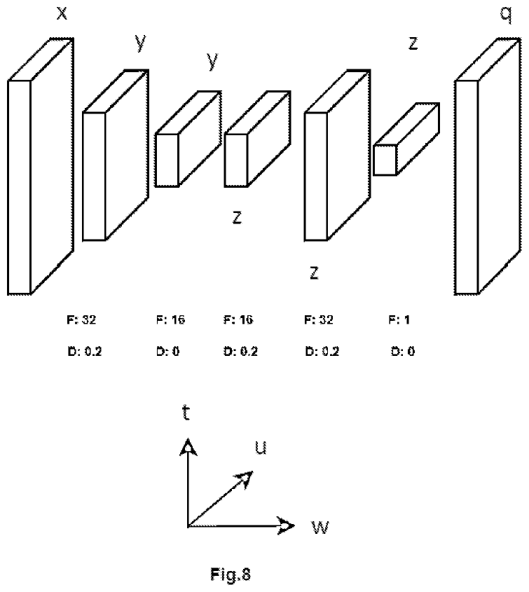

The detailed architecture of the machine learning-based black hole prediction module (5), which is a convolutional autoencoder (Conv-AE) black hole prediction module designed specifically for the problem, is shown in FIG. 8. Here, when two-dimensional tabular data is the instances and attributes, the history is ‘m’ minutes, the window size is: ‘m’ and the current time is: ‘t’, (‘t−1’, ‘t−2’, . . . , ‘t−m’) is prepared by window sliding approach and presented to the model as an input. Wherein: the architecture of the problem-specific convolutional autoencoder, wherein x:Input, y:Convolutional-1D, z:T-Convolutional-1D, q:Output, t:Attributes, u:Window size, and w:Instances. The elements in the convolutional autoencoder in FIG. 8, their functions and their numerical values;
Convolutional-1D: Forms a convolution core which convolutes on a single temporal dimension with the input layer.
T-Convolutional-1D: A converted (transformed) convolution layer and also called deconvolution. The need for the transformed convolutions originates from the desire to use a transformation that goes in the opposite direction of a normal convolution, that is, from something that has a shape of the output of a convolution to something that has a shape of its input while maintaining a connection pattern compatible with said convolution.
F: The number of filters in the convolutional layer.
D: The proportion of the ones to be dropped from the learned weights.
Reconstruction Loss: Calculated by Mean Absolute Error function.
Model Optimization: Performed using the Adam algorithm with a learning rate of 0.001.
Window Size (m): Indicates how much historical instance data is kept for each instance and has a value of 72.

The characteristic behavior of the black hole router is that it accepts a request to send any packet on an end-to-end basis over the backbone network, claiming that the shortest path passes over itself, and then drops the packet instead of forwarding it. Therefore, the quantity of input data is quite high in network routers exhibiting black hole behavior, while the quantity of output data is very low as the packets are not transmitted. Interpreting the input and output packet rates to determine the black hole router may only be done after the black hole has occurred, and does not offer a solution to take precautions against a black hole attack. In order to take precautions against the black hole attacks and to prevent them, the black hole prediction is needed using the machine learning and deep learning methods before a black hole occurs.

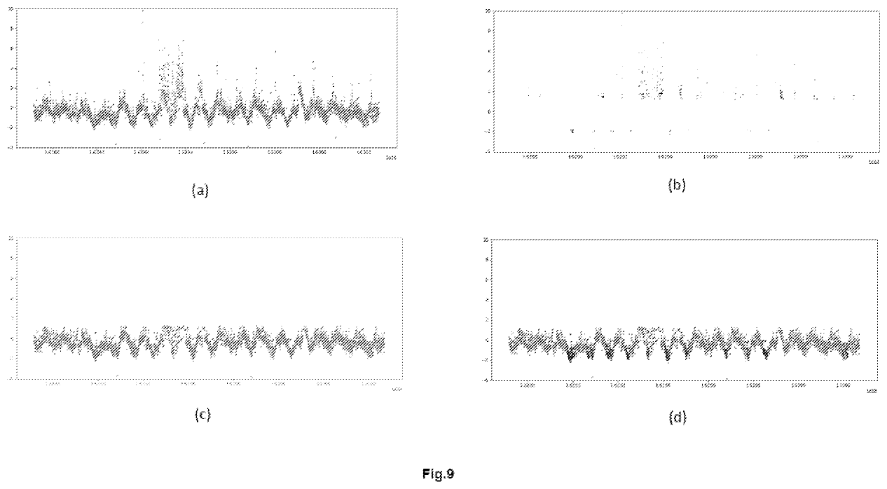

FIG. 9 shows an example of the outputs produced by the Black Hole Prediction Model application. Where the x-axis denotes the recording time in UNIX time, and the y-axis denotes the normalized values of the mean output packet rate attribute in a router. FIG. 9(a) shows the raw version of the output packet ratio data before any detection process is made. FIG. 9(b) shows the DBSCAN results obtained in the unlabeled data tagging module (3), and these data points represent the point anomalies detected through the DBSCAN algorithm. FIG. 9(c) shows the data converged to normal obtained as a result of updating (4) the values of the point anomaly instances detected by the DBSCAN with the closest instance values of the normal group. FIG. 9.(d) shows the final results obtained with the Black Hole Prediction Model, wherein the black hole anomalies detected by the final model proposed are represented in bold. The point anomalies detected in FIG. 9.(b) and the black hole anomaly points detected in FIG. 9(d) together represent the point, contextual, and collective anomalies. The point anomalies detected by the DBSCAN are replaced with the closest normal data in the anomaly data replacing module (4), Conv-AE uses this converged data as an input, and the contextual and collective anomalies, including the black hole instances, are detected in addition to the point anomalies. Here, it is especially desired to detect anomalies for which the number of output packets is less than the expected value. This is because the routers that exhibit black hole behavior drop packets instead of forwarding them. FIG. 9(d) shows cases where less data flow is observed in the output package than expected (for example, time: ~16,290, ~16,291, ~16,294) are provided by the black hole prediction and detection system by computer-aided machine learning in the software the backbone infrastructure networks of the invention.

1. A black hole prediction and detection system by computer-aided machine learning comprising at least one processor in software backbone infrastructure networks, characterized in that it comprises:
a data collection module (1) which determines the relevant data set during the black hole detection, constantly monitors the system by a remote connection unit and while doing so, prevents the system from being exhausted by the data flow traffic, thereby not affecting the performance of the system, wherein the data collection module observes and collects the network parameters in a router via the sensors in the routers and is a structure where time series network data is collected using YA NG data models,
a data pre-processing module (2) which prepares the data for the machine learning algorithms in the studies carried out on data using machine learning-based algorithms and is a structure where the data pre-processing processes are carried out,
an unlabeled data tagging module (3) which is a structure in which outliers such as point anomalies in the data are obtained by creating a new clustering model suitable for the problem via the Density-Based Spatial Clustering of Applications with Noise (DBSCAN), one of the machine learning clustering methods,
an anomaly data replacing module (4) which obtains data converged to a normal group from the unlabeled data,
a machine learning-based black hole prediction module (5) which helps the data to converge to normal and is used in combination with the problem-specific autoencoder Conv-AE architecture sliding window technique,
an explanation module (6) of the machine learning-based method, in which a score is obtained for the black hole instances at the model output via the explainable machine learning method and determines from which neurons in the network and which attributes in the data this score originates,
a module (7) for collecting current data from YANG model sensors, which is a structure in which the current time series network data collected using YANG data models is periodically transferred to the system,
an off-line updating module (8) of the black hole prediction model, which is a structure in which the machine learning-based black hole prediction module (5) is updated.

2. A black hole prediction and detection system by computer-aided machine learning comprising at least one processor in software backbone infrastructure networks according to claim 1, characterized in that said remote connection unit is Ethernet in the data collection module (1) which determines the relevant data set during the black hole detection and constantly monitors the system by the remote connection unit.

3. A black hole prediction and detection system by computer-aided machine learning comprising at least one processor in software backbone infrastructure networks according to claim 1, characterized in that said remote connection unit is Wifi in the data collection module (1) which determines the relevant data set during the black hole detection and constantly monitors the system by the remote connection unit.

4. A black hole prediction and detection system by computer-aided machine learning comprising at least one processor in software backbone infrastructure networks according to claim 1, characterized in that said data collection module (1) is a hard disk.

5. A black hole prediction and detection system by computer-aided machine learning comprising at least one processor in software backbone infrastructure networks according to claim 1, characterized in that said remote connection unit is Ethernet in a module (7) for collecting current data from YANG model sensors, is a structure in which the current time series network data collected using YANG data models is periodically transferred to the system in order to observe and collect the network parameters in the router via the remote connection unit that provides communication.

6. A black hole prediction and detection system by computer-aided machine learning comprising at least one processor in software backbone infrastructure networks according to claim 1, characterized in that said remote connection unit is Wifi in a module (7) for collecting current data from YANG model sensors, is a structure in which the current time series network data collected using YANG data models is periodically transferred to the system in order to observe and collect the network parameters in the router via the remote connection unit that provides communication.

7. A black hole prediction and detection system by computer-aided machine learning comprising at least one processor in software backbone infrastructure networks according to claim 1, characterized in that the module (7) for collecting current data from YANG model sensors is a hard disk, which is a structure in which the current time series network data collected using YANG data models is periodically transferred to the system in order to observe and collect the network parameters in the router via the remote connection unit that provides communication.

8. An operation method of a black hole prediction and detection system by computer-aided machine learning comprising at least one processor in software backbone infrastructure networks according to claim 1, characterized in that it comprises the following process steps:
i. examining the YANG data models (1001),
ii. determining the YANG data models and attributes thought to be associated with the black hole (1002),
iii. collecting the time series data (1003),
iv. removing the attributes which do not contain any information on time-varying network conditions in black hole prediction, but a single value from the data (2001),
V. detecting instances for which the numeric attributes contain alphabetic characters due to typographical errors and errors caused by a human error during a data recording process, and removing them from the data (2002),
vi. detecting the machine learning algorithms of the non-numeric categorical attributes as they have no input and making them ready for use using one-hot-encoding and label encoding algorithms (2003),
vii. detecting the values which are not present in the dataset and filling in said values by the method of back filling (bfill) the missing values in the dataset and/or forward filling (ffill) the missing values in the dataset, instead of removing said values from the data (2004),
viii. understanding the relationship between the attributes by generating a correlation matrix and reducing the calculation time and increasing the generalization ability of the models by keeping only one of the highly correlated attributes in the dataset and removing the other (2005),
ix. determining the acceptable limits for the attribute-based sparsity rate, which is the number of zeros in an attribute column divided by the number of instances of the attribute, and keeping the attributes within these limits in the data and eliminating the others (2006),
x. observing the time series characteristics of the black hole data by time-dependent visualization of the attributes (2007),
xi. due to the fact that the data flow in the network shows a time-dependent pattern, generating the required time-related attributes such as minutes, week of the year, day of the week, etc., by being acquired from the instance recording date information (2008),
xii. generating the additional attributes which are thought to accurately express the black hole characteristic and the input/output packet/data/load ratios to be made on the existing attributes (2009),
xiii. investigating the correct values for two basic hyperparameters, Epsilon and Minimum Points, for the most accurate DBSCAN method (3001),
xiv. deciding on the accurate DBSCAN model based on Silhouette Score and Davies Bouldin Score performance metrics (3002),
xv. marking the data as point anomaly or normal by DBSCAN (3003),
xvi. updating the values of the point anomaly instances with the closest instance values of the normal group by using the bfill and/or ffill methods (3004),
xvii. investigating the problem-specific autoencoder architecture (4001),
xviii. checking the black hole prediction performance of the candidate autoencoder models using the attribute-based visualizations as the data is unlabeled (4002),
xix. evaluating the performance of the candidate autoencoder models according to the detection precision to be determined by a specialist (4003),
xx. combining the evaluation results and deciding on the accurate autoencoder model (4004),
xxi. marking the data as a black hole or normal with the machine learning-based black hole prediction module (5) containing an autoencoder specially designed for the problem (4005),
xxii. generating an explanation for the instances detected as black holes by XAI methods (4006).
